(19) United States
(12) Patent Application Publication
(10) Pub. No.: US 2015/0104580 A1
(43) Pub. Date: Apr. 16, 2015

(54) SYSTEM FOR APPLYING VISCOUS SUBSTANCES

(71) Applicant: BRAMAL INC., Coteau-Du-Lac (CA)

(72) Inventors: Mathieu MALBOEUF, Coteau-du-Lac (CA); Dorian BRAUN, Pointe-Claire (CA)

(21) Appl. No.: 14/577,596

(22) Filed: Dec. 19, 2014

Related U.S. Application Data
(62) Division of application No. 13/224,759, filed on Sep. 2, 2011.
Application No. 13/224,759 is a continuation of application No. PCT/CA2010/000306, filed on Mar. 3, 2010.

(51) Int. Cl. B05B 7/14; B05D 1/12; B05B 7/16; B05D 1/34

(52) U.S. Cl. CPC B05B 7/1436; B05D 1/34; B05D 1/12; B05B 7/166
USPC 427/422; 427/426

(57) ABSTRACT

A system for applying viscous substances is formed from a liquid and a granular solid. The system comprises a liquid circuit with a liquid containment unit. A liquid line and conveying means circulate the liquid from the liquid containment unit into the liquid line. A solid circuit with a storage unit stores the granular solids. A solid line and conveying means circulate the granular solids from the storage unit into the solid line. A mixing device is connected to the liquid line and to the solid line. The mixing device has a body that is adapted to receive liquids from the liquid line and granular solids from the solid line. The body mixes the liquids and granular solids into a viscous substance. The body has an outlet to apply the viscous substance mixed in the body. A method for applying a viscous substance is also provided.

### CROSS-REFERENCE TO RELATED APPLICATION(S)

The present application is a divisional of U.S. Non-Provisional application Ser. No. 13/224,759 filed Sep. 2, 2011 which is a continuation of International Patent Application No. PCT/CA2010/000306, and claims the benefit of U.S. Provisional Application No. 61/156,967, filed on Mar. 3, 2009, and incorporated herein by reference.

### FIELD OF THE APPLICATION

The present application relates to a system for applying viscous substances and, more particularly, for mixing solids and liquids, and/or gas and applying the resulting viscous substances.

### BACKGROUND OF THE ART

The application of viscous substances, such as elastomers, involves specialized equipment due to a plurality of factors. As viscous substances tend to be resistive by nature, pumps/blowers must be large and powerful, and lines must have important diameters for limited lengths to avoid being clogged up. These two limitations are two of numerous factors to be considered when designing specialized equipment to apply a viscous substance.

### SUMMARY OF THE APPLICATION

It is an aim of the present application to provide a novel system and a novel method for applying viscous substances.

Therefore, in accordance with a first embodiment of the present application, there is provided a system for applying viscous substances formed from at least one liquid and at least one granular solid comprising: a first liquid circuit with a first liquid containment unit, a first liquid line and conveying means adapted to circulate the first liquid from the liquid containment unit into the first liquid line; a first solid circuit with a first storage unit adapted to store the granular solids, a first solid line and conveying means adapted to circulate the granular solids from the first storage unit into the first solid line; and a mixing device connected to the first liquid line and to the first solid line, the mixing device having a body adapted to receive liquids from at least the first liquid line and granular solids from the first solid line, and to mix the liquids and granular solids into a viscous substance, and an outlet to apply the viscous substance mixed in the body.

Further in accordance with the first embodiment, the body of the mixing device has a pipe, the pipe connected at a first end to the first solid line, a second end of the pipe being the outlet, a lateral entry being defined in the pipe between the first end and the outlet for receiving liquids from the first liquid circuit.

Still further in accordance with the first embodiment, the pipe has obstruction members therein to create a turbulence in the pipe for the subsequent mixture of solids and liquids.

Still further in accordance with the first embodiment, the system further comprises a second liquid circuit with a second liquid containment unit, a second liquid line and conveying means adapted to circulate the second liquid from the liquid containment unit into the second liquid line to the mixing device for mixing the second liquid into the viscous substance.

Still further in accordance with the first embodiment, a static mixer receives the liquids from the first liquid line and the second liquid line to mix fluids, the static mixer connected to the body of the mixing device to feed the fluids for mixture with the solids.

Still further in accordance with the first embodiment, a manifold is connected to a first end of the static mixer, the manifold having two fluid inlet ports respectively connected to the first liquid line and the second liquid line, the fluid inlet ports connected to channels into the manifold merging into an outlet port, with the static mixer being connected to the outlet port of the manifold.

Still further in accordance with the first embodiment, check valves are positioned in the channels of the manifold.

Still further in accordance with the first embodiment, a maintenance line in the manifold is in fluid communication with the channels, the maintenance line having at least one port for air/solvent, the maintenance line having at least one check valve between the at least one port and the channels.

Still further in accordance with the first embodiment, the system further comprises a second solid circuit with a second storage unit adapted to store granular solids, a second solid line and conveying means adapted to circulate the granular solids from the second storage unit into the second solid line, the second solid line merging into the first solid line of the first solid circuit.

Still further in accordance with the first embodiment, the conveying means of the first solid circuit comprises a positive displacement device between the first storage unit and the first solid line to control the granular solids exiting the first storage unit, and a blower creating a flow of gas in the first solid line.

Still further in accordance with the first embodiment, the first liquid containment unit is an insulated reservoir, with a heating element to heat the first liquid.

In accordance with a second embodiment of the present application, there is provided a method for applying a viscous substance at a given location comprising: storing at least a first liquid at a position remote from the given location; storing at least a first granular solid at a position remote from the given location; conveying the first liquid and the first granular solid to the given location in separate pipes; mixing at least the first liquid and the first granular solid under pressure to create the viscous substance; and outletting the viscous substance under pressure to apply the viscous substance at the given location.

Further in accordance with the second embodiment, a second liquid is stored at a position remote from the given location, conveying the first liquid, the second liquid and the first granular solid to the given location in separate pipes, and mixing the first liquid, the second liquid and the first granular solid under pressure to create the viscous substance.

Still further in accordance with the second embodiment, mixing the first liquid, the second liquid and the first granular solid comprises mixing the first liquid and the second liquid prior to mixing them with the first granular solid.

Still further in accordance with the second embodiment, the method further comprises storing at least a second granular solid at a position remote from the given location, conveying the second granular solid with the first granular solid to mix at least with the first liquid.

Still further in accordance with the second embodiment, conveying the first granular solid comprises entraining the first granular solid in a gas flow.

Still further in accordance with the second embodiment, a turbulent flow of the first granular solid is created prior to mixing the first granular solid with at least the first liquid.

Still further in accordance with the second embodiment, at least the first liquid is heated during said storing.

### BRIEF DESCRIPTION OF DRAWINGS

FIG. 1 is a schematic view of a system for applying viscous substances in accordance with an embodiment of the present disclosure;

FIG. 2 is a schematic view of a liquid/solid mixing device in relation with a static mixer, as used in the system of FIG. 1; and

FIG. 3 is a schematic view of a manifold of the system of FIG. 1.

### DESCRIPTION OF PREFERRED EMBODIMENTS

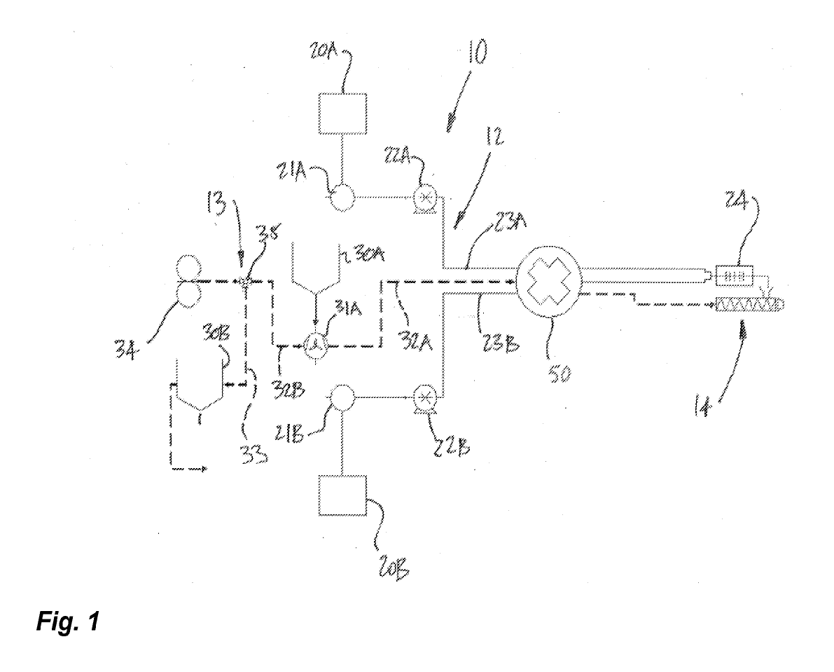

Referring to the drawings and more particularly to FIG. 1, a system for applying viscous substances is generally shown at 10. The system 10 is used to mix solids and liquids, and gases if necessary, into a viscous substance. The viscous substance is then applied by the system 10.

The system 10 has a liquid circuit 12 and a solid circuit 13. The liquid circuit 12 and the solid/gas circuit 13 respectively convey solids and liquids to a liquid/solid/gas mixing device 14. The mixing device 14 will mix the liquids solids and/or gas. In the present embodiment, the liquids and a solid/gas will react to produce a viscous substance. The viscous substance is then applied by the mixing device 14.

In the preferred embodiment, the process begins in four distinct stages of “raw materials” (i.e., two liquid phases and two solid phases), in addition to gas. The two liquid phases can be composed of any liquids. For this particular application, reference will be made to resins as liquid A and a catalyst as liquid B.

The liquids A and B are respectively stored in tanks 20A and 20B, or like containment means. Since they may be sensitive to the environment, the liquids A and B must be contained in appropriate containment apparatuses. In the preferred embodiment, the liquids A and B are sensitive to moisture in its pure form (water) or in the air, so the containment apparatus in this specific application may be totes (e.g., 1000 L HDPE containers) which are preferably adequate for transport on the road. The totes are sealed to the outside and are preferably equipped with desiccate breathers to ensure that air intake has low humidity. The totes are equipped with the appropriate fittings and connectors to be plumbed up to pumps.

As another example, the tanks 20A and/or 20B may be heated to maintain the liquids A and/or B with a low viscosity in view of being mixed with a solid. It is considered to heat the tanks 20A and/or 20B with excess heat discharged from an internal combustion power generation unit (i.e., generator). The heat may be the cooling fluid in a hot state, namely a by-product of combustion exhaust. The tanks 20A and/or 20B may be aluminum tanks, among other possibilities, with external insulation, and incorporating heating elements (e.g., heat exchangers) as mentioned above.

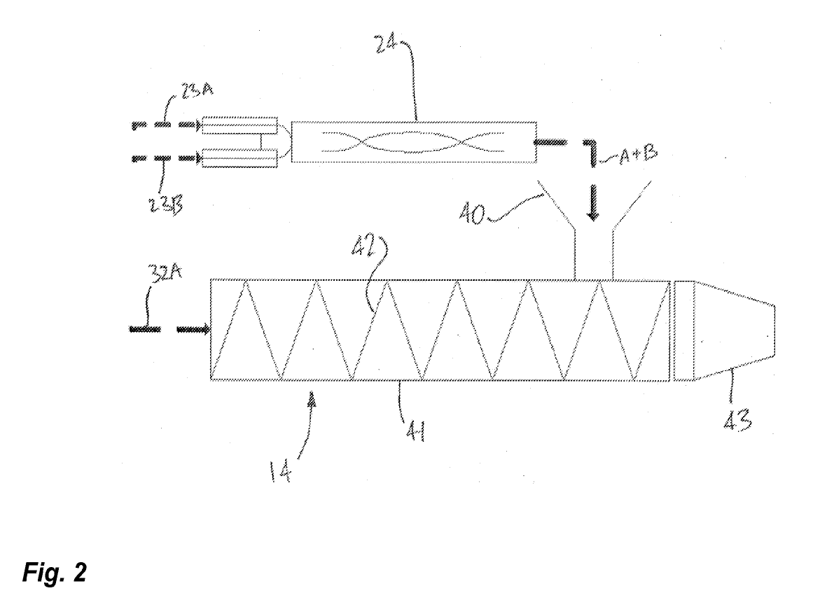

The liquid circuit 12 has two branches that merge downstream. One of the branches is for liquid A and the other for liquid B. However, the branches are similar in configuration, whereby the branches will be described concurrently. In FIGS. 1 and 2, letters “A” and “B” are affixed to the components of the branches to illustrate the components that are used with liquid A or liquid B, respectively.

Upon exit of the tanks 20, the liquids are sucked by pumps 21, such as supercharging pumps or any other appropriate type of pump. The role of the pump 21 is to ensure a constant feed to supply pumps 22 (e.g., piston pump in this case). This is done in order to prevent air bubbles or liquid cavitation. This problem mainly occurs when working with high-viscosity fluids. Supercharging pumps may be used, especially if the liquids are not heated, and thus have a higher viscosity.

The main positive displacement pumps 22 then feed the liquids A and B through a length of hose 23 appropriate for application (e.g., 400 ft in this case). In this particular embodiment, a triple piston pump may be used as the pump 22. This particular type of pump is used in order to ensure that the flow of the liquids from the pumps 22 will be as uniform and laminar as possible without pulsations. Since the pistons are offset, the uniformity of the flow is improved.

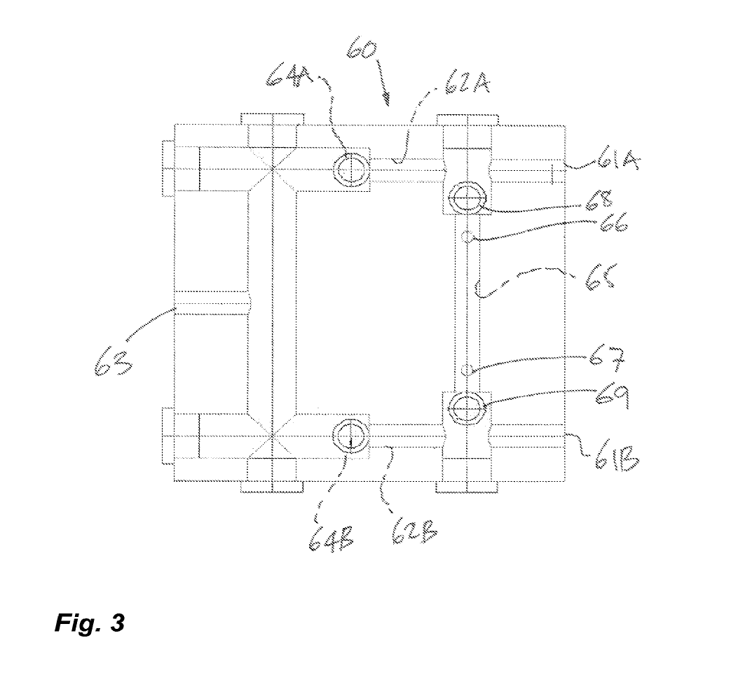

Referring to FIG. 2, the liquids A and B then merge together, for instance using a T-type fitting coupled to a mixer 24, or a manifold as shown in FIG. 3 and describe in more details hereinafter. In the present case, the mixer 24 may be a multi-stage unit (e.g., 32 stages) which ensures thorough mixing of fluids. The static mixer 24 is a tube with no moving parts that mixes two or more liquids in order to obtain shear mixing and uniform distribution of the liquids. Uniform mixing is important when mixing catalysts and resins. Once the liquids A and B are mixed, they are then projected at the point of exit into the pneumatic conveying stream, via the mixing device 14. Alternatives to a static mixer are considered as well, including any suitable blending device.

Referring to FIG. 1, the solid circuit 13 is used to bring at least one solid into the mix. In the present embodiment, a single solid is part of the mix, but the system 10 also applies a second solid. The solids will be identified as solid A and solid B, with solid A being mixed with the liquids A and B. The two solid phases can be composed of any solids. For this particular application, reference will be made to tire crumb (grind, particulate, powder, etc.) for solid A (or granular solid) and silica (sand, rocks, etc.) for solid B.

The solids are stored in hoppers or like storage means, illustrated at 30 in FIG. 1 (with letters A and B to identify which solid from A or B the component is associated with). The hoppers 30 may be housed inside a mobile production unit. The hoppers 30 can be constructed from any durable material and may have a side entry for maintenance as well as a bottom hopper chute which allows the material to drop down into a dosing mechanism 31A.

The dosing mechanism 31A for solids is at a bottom of the hopper 30A. In the present case, a positive-displacement device such as a screw feeder, gate feeder, conveyor belt or rotary feeder is used as dosing mechanism 31A, amongst numerous other possibilities. The dosing mechanism 31A ensures that a constant volumetric feed of tire crumb is achieved. The amount delivered is dependent on the rotational speed of the dosing mechanism 31A. As the dosing mechanism 31A rotates, it drops material into the pneumatic conveyor.

The pneumatic conveyor has a conveying line 32 typically made of hose, and a positive-displacement Roots blower 34, which is a high-CFM, low-pressure blower. The blower 34 in this case uses air or gas as the carrying medium which, in turn, brings the respective solids A and B to their desired location. Other devices can be used as an alternative to the positive-displacement blower 34, such as a scroll compressor or the like.

Upon exit from the dosing mechanism 31A, a diffuser tube may be used. The diffuser tube is a tube, in this case of diameter equal to that of the feed lines. This tube is constructed of a high-density material, for instance ABS plastic. The tube is filled with obstructions across its surface area so that, if a person were to look through the tube, it would be difficult to see a clear path from one end to another. This is done to dissipate and diffuse solid A specifically so that it does not suffer from pulsations which lead to irregular or erratic flow characteristics. The length and diameter of the tube can change the diffuser's performance. These parameters are material- and application-dependent.

Once solid A has passed the dosing mechanism 31A, it reaches the liquid/solid mixing device 14. The mixing device 14 mixes liquids A and B and at least one of the solids in proportion to attain a finished, continuously applied product. The mixing device 14 can mix many different types of solids, liquids and gases, depending on the application.

Referring to FIG. 2, the entry point 40 of the mixing device 14 for the liquids A and B is located on top of the device 14. Although not illustrated, the static mixer 24 may be connected to the mixing device 14 by locking quick-connector couplers which allow ease of disassembly and clean-up. The pneumatic conveying stream coming from the line 32A (air/tire crumb—in our case carried in dilute phase), is coupled to a rigid pipe/tube 41 of the mixing device 14. The rigid pipe 41 may be with or without mixing obstructions 42 that have been form-fitted or molded for a specific application. A bend may be provided at the outlet of the tube 41 to affect the output from the mixing device 14. The obstructions can help to create turbulent flow characteristics in the tube 41, which can help mix the desired components together. The choice of whether or not to add some obstructions is material-dependent.

The end 43 of the mixing device 24 can be throttled to increase flow velocity or to change the spray pattern for a specific application. As the diameter and, to a certain extent, the length of the pipe 41 change, the flow characteristics also change. The threshold of functionality is very narrow, and designing the proper device is material- and application-dependent.

In the present embodiment, there is a necessity to apply a silica surface treatment. The silica treatment is applied via an independent pneumatic line, as illustrated at 33, or through the pneumatic conveyor used for solid A. Because the cost of the silica is minimal, accurate metering of this material is not required, whereby pressurized air may be collected from the positive displacement device 34 (e.g., Roots blower) through valve 35, and directed to the independent line 33. The silica simply showers out onto the surface and, when the operator has enough material, the machinery is stopped.

Alternatively, the silica may be applied using the pneumatic conveyor of solid A. The three-way valve 35 is used to connect line 33 to the line 32B. The line 32B then connects into the dosing mechanism 31A, to finally reach the line 32A.

Additionally, it often happens in practice that there are fluctuations in the flow rate due to twists and turns in the flexible hose length or other unpredictable factors. It is considered to automate the above-described system in order to accommodate for such fluctuations. The system may have sensors of various types at strategic points, which are read regularly. The sensors trigger compensatory elements through a pre-established set of algorithms via a control processor which, in turn, varies the drive motor speeds through a variable-speed drive.

Referring to FIG. 1, a winch 50 or hose reel is provided to dispense or accumulate the hoses of lines 23A, 23B and 32A. The winch 50 or hose reel represents a suitable way to store the lines in a mobile production unit, and may be motor-driven.

Referring to FIG. 3, a manifold used with the mixing device 24 is generally shown at 60. The manifold 60 is upstream of the mixing device 24, and is one of the numerous devices that may be used to mix the liquids A and B. The manifold 60 has inlet ports 61A and 61B, for receiving the lines 23A and 23B, respectively. Channels 62A and 62B merge into an outlet port 63. The outlet port 63 is connected to the mixer 24, to output the combination of liquids A and B, which combination will further be mixed in the mixer 24, as described above.

Check valves 64A and 64B are positioned in the channels 62A and 62B, respectively, to ensure that liquid B does not go into the line 23A, and vice versa. Common maintenance line 65 merges with both channels 62A and 62B, and has a solvent port 66, and/or an air port 67, as well as check valves 68 and 69, to ensure the unidirectional flow of solvent and/or air to the channels 62A and/or 62B during maintenance.

Now that the system 10 has been described as a whole, the various components thereof are described in more detail.

The hoses used in the system (tubing, pipes, etc., rigid or flexible) for the lines 23A, 23B and/or 32A may be constructed from a variety of materials. A preferred material of construction would be polymers. The hose or tubing body can be reinforced or unreinforced. This can be done with a variety of compositions, braids and reinforcing materials. The length and diameter can vary depending on the material and application of the equipment. Some sizes may be referred to herein for better understanding of the system only; they are not meant to be limiting in nature, but rather they are there on an informative basis. Also, the silica may be abrasive, whereby it is considered to use hose materials that can withstand the silica or like granular materials.

Fittings may be used to increase or reduce the diameter of hosing or tubing, and may also be used to create or reduce additional passages for flow of a specific medium. In some cases, special fittings and attachments are used for a specific purpose, whether it be for the prevention of air entrainment or ease of connectivity.

Amongst the numerous positive displacement devices that may be used, the rotary feeder 31A is commonly used in industrial and agricultural applications as a component in a bulk or specialty material-handling system. Rotary feeders are primarily used for discharge of bulk solid material from hoppers/bins, receivers and cyclones into a pressure- or vacuum-driven pneumatic conveying system. Components of a rotary feeder include a rotor shaft, housing, head plates, packing seals and/or bearings. Rotors have large vanes cast or welded on and are typically driven by small internal-combustion engines or electric motors.

Rotary airlock feeders have wide applications in industry wherever dry, free-flowing powders, granules, crystals, or pellets are used. Typical materials include cement, ore, sugar, minerals, grains, plastics, dust, fly ash, flour, gypsum, lime, coffee, cereals, pharmaceuticals, etc.

Rotary valves are available with square or round inlet and outlet flanges. Housings can be fabricated out of sheet material or may be cast. Common materials are cast iron, carbon steel, stainless steel (e.g., 304, 316) and other materials. Rotary airlock feeders are often available in standard and heavy-duty models, the difference being the headplate and bearing configuration. Heavy-duty models use an outboard bearing in which the bearings are moved out away from the headplate. Housing inlet and discharge configurations are termed drop-through or side entry. Different wear protections are available, such as hard chrome or ceramic plating on the inner housing surfaces. Grease and air-purge fittings are often provided to prevent contaminants from entering the packing seals.

The basic use of the rotary airlock feeder is as an airlock transition point, sealing pressurized systems against loss of air or gas while maintaining a flow of solid material between components with different pressures, and suitable for airlock applications ranging from gravity discharge of filters, rotary valves, cyclone dust collectors, and rotary airlock storage devices to precision feeders for dilute phase and continuous dense phase pneumatic conveying systems.

Rotary airlock feeders/rotary airlock valves are used in pneumatic conveying systems, dust control equipment, and as volumetric feed controls. Rotary airlock valves are also widely used as volumetric feeders for metering materials at precise flow rates from bins, hoppers, or silos onto conveying or processing systems.

Blow-through rotary airlock feeders are similar to the other rotary devices described above, except the material is dropped into a pipe which is part of the rotary feeder. One end of the pipe is hooked to an air feed and the other end is hooked to a delivery hose. This is done so that the material dropped into the pipe can be “blown through.”

The Roots type supercharger or Roots blower 34 is a positive displacement pump that operates by pulling air through a pair of meshing lobes, similarly to a set of stretched gears. Air is trapped in pockets surrounding the lobes and carried from the intake side to the exhaust. The blower is driven directly from the engine's crankshaft via a belt or, in an engine, by spur gears.

Roots blowers are typically used in applications where a large volume of air must be moved across a relatively small pressure differential. This includes low-vacuum applications, with the Roots blower acting alone, or used as part of a high-vacuum system, in combination with other pumps.

Because rotary lobe pumps need to maintain a clearance between the lobes, a single stage Roots blower can pump gas across a limited pressure differential. If the pump is used outside its specification, the compression of the gas generates so much heat that the lobes expand to the point that they may jam, damaging the pump. Roots pumps are capable of pumping large volumes but, as they only achieve moderate compression, it is not uncommon to see multiple Roots blower stages, frequently with heat exchangers (intercoolers) in between to cool the gas.

The term “blower” is commonly used to define a device placed on engines with a functional need for additional airflow using a direct mechanical link as its energy source. The term “blower” is used to describe different types of superchargers. A screw type supercharger, Roots type supercharger, and a centrifugal supercharger are all types of blowers. Conversely, a turbocharger, using exhaust compression to spin its turbine, and not a direct mechanical link, is not generally regarded as a “blower” but simply a “turbo,” but for practical purposes, they are all considered to be the same.

Pneumatic conveyors are often hooked up to such blower packages, and consist of a hose or tubing hooked to the output of the blower (sometimes the input for vacuum systems). The hose or tubing acts as a conveyor belt in that it allows for a material (conveyed medium) to be fed into the air stream or conveying medium, which is then released to atmosphere at some specific point down the line depending on application and conveying medium and conveyed medium.

Hoppers 20A and 30B (i.e., tank, reservoir, storage element, etc.) are generally defined as a chute with additional width and depth to provide a volume for temporary storage of material(s). The bottom of the hopper chute typically has a mechanism to control the flow of materials, thus allowing them to be metered out at the desired rate.

A pump is a device used to move mediums such as gases, liquids or slurries and, even in some cases, solids. A pump displaces a volume by physical or mechanical action. Pumps displace fluid causing a flow. Adding resistance to flow causes pressure build-up.

Pumps, such as pumps 22A and 22B, fall into two major groups: positive displacement pumps and rotodynamic pumps. Their names describe the method for moving a fluid. Because of the wide variety of applications, pumps have a plethora of shapes and sizes: from very large to very small, from handling gas to handling liquid and solids, from high pressure to low pressure, and from high volume to low volume.

A positive displacement pump causes a medium to move by trapping a fixed amount of it, then forcing (displacing) that trapped volume into the discharge pipe. A positive displacement pump can be further classified as either:
Screw feeder;
Gate feeder;
Conveyor belt;
plunger pump;
triplex pump;
double action piston pump;
Rotary vane-type (as seen above), can be considered a pump;
Lobe pump;
Roots type (as seen above), can be considered a pump;
Progressive cavity pump;
Plunger or piston pump (also called reciprocating-type pumps);
Diaphragm (in a preferred embodiment, the diaphragm will be referred to as supercharging pumps);
Peristaltic compressors or pumps;
Gear pumps.

Reciprocating-type pumps use a piston and cylinder arrangement with suction and discharge valves integrated into the pump. Pumps in this category range from having one cylinder (simplex) to, in some cases, four cylinders (quad) or more. Most reciprocating-type pumps are two or three cylinders. Furthermore, they are either “single-acting” independent suction and discharge strokes or “double-acting” suction and discharge in both directions. The pumps can be powered by air, steam or through a belt drive from an engine or motor, gear-coupled, etc.

Another modern application of positive displacement pumps are double-diaphragm pumps. A diaphragm pump is a positive displacement pump that uses a combination of the reciprocating action of a rubber, thermoplastic or teflon diaphragm and suitable non-return check valves to pump a fluid. Sometimes, this type of pump is also called a membrane pump.

There are three main types of diaphragm pumps:
In the first type, the diaphragm is sealed with one side in the fluid to be pumped, and the other in air or hydraulic fluid. The diaphragm is flexed, causing the volume of the pump chamber to increase and decrease. A pair of non-return check valves prevent reverse flow of the fluid.
As described above, the second type of diaphragm pump works with volumetric positive displacement, but differs in that the prime mover of the diaphragm is neither oil nor air; but is electromechanical, working through a crank or geared motor drive. This method flexes the diaphragm through simple mechanical action, and one side of the diaphragm is open to air.
The third type of diaphragm pump has one or more unsealed diaphragms with the fluid to be pumped on both sides. The diaphragm(s) again are flexed, causing the volume to change.

When the volume of a chamber of either type of pump is increased (the diaphragm moving up), the pressure decreases, and fluid is drawn into the chamber. When the chamber pressure later increases from decreased volume (the diaphragm moving down), the fluid previously drawn in is forced out. Finally, the diaphragm moving up once again draws fluid into the chamber, completing the cycle. This action is similar to that of the cylinder in an internal combustion engine.

Diaphragm pumps have good suction lift characteristics. Some are low-pressure pumps with low flow rates. Others are capable of higher flow rates, dependent on the effective working diameter of the diaphragm and its stroke length. They can handle sludges and slurries with a good amount of grit and solid content.

Concerning the powering of the system 10, it is preferred that the system 10 run off grid power or independently. It is equipped with a generator that can run the entire system alone on site (if need be) for a non-negligible period of time.

An engine generator is the combination of an electrical generator and an engine (prime mover) mounted together to form a single piece of equipment. This combination is also called an “engine generator set” or a “gen-set.”

In addition to the engine and generator, engine generators generally include a fuel tank, an engine speed regulator and a generator voltage regulator, cooling and exhaust systems, and lubrication system. Units larger than about 1 kW rating have a battery and electric starter; very large units may start with compressed air. Standby power generating units often include an automatic starting system and a transfer switch to disconnect the load from the utility power source and connect it to the generator.

Engine generators are used to supply electrical power in places where utility (central station) power is not available, or where power is needed only temporarily. Small generators are sometimes used to supply power tools at construction sites. Trailer-mounted generators supply power for temporary installations of lighting, sound amplification systems, process equipment, etc.

A variable-frequency drive (VFD) is a system for controlling the rotational speed of an alternating current (AC) electric motor by controlling the frequency of the electrical power supplied to the motor. A variable-frequency drive is a specific type of adjustable-speed drive. Variable-frequency drives are also known as adjustable-frequency drives (AFD), variable-speed drives (VSD), AC drives, microdrives or inverter drives. Since the voltage is varied along with frequency, these are sometimes also called VVVF (variable-voltage variable-frequency) drives.

Variable-frequency drives are widely used. For example, in ventilations systems for large buildings, variable-frequency motors on fans save energy by allowing the volume of air moved to match the system demand. Variable-frequency drives are also used on pumps and machine tool drives.

Variable-frequency drive controllers are solid-state electronic power conversion devices. The usual design first converts AC input power to DC intermediate power using a rectifier bridge. The DC intermediate power is then converted to quasi-sinusoidal AC power using an inverter switching circuit. The rectifier is usually a three-phase diode bridge, but controlled rectifier circuits are also used. Since incoming power is converted to DC, many units will accept single-phase as well as three-phase input power (acting as a phase converter as well as a speed controller). However, the unit must be derated when using single-phase input as only part of the rectifier bridge is carrying the connected load.

As new types of semiconductor switches have been introduced, these have promptly been applied to inverter circuits at all voltage and current ratings for which suitable devices are available.

A programmable logic controller (PLC), or control processor, is a digital computer used for automation of electromechanical processes, such as control of machinery on factory assembly lines, control of process equipment, or control of lighting fixtures. Unlike general-purpose computers, the PLC is designed for multiple input and output arrangements, extended temperature ranges, immunity to electrical noise, and resistance to vibration and impact. Programs to control machine operation are typically stored in battery-backed or non-volatile memory. A PLC is an example of a real-time system, since output results must be produced in response to input conditions within a bounded time, otherwise unintended operation will result.

The main difference from other computers is that PLCs are armored for severe conditions (dust, moisture, heat, cold, etc.) and have the facility for extensive input/output (I/O) arrangements. These connect the PLC to sensors and actuators. PLCs read limit switches, analog process variables (such as temperature and pressure), and the positions of complex positioning systems. On the actuator side, PLCs operate electric motors, pneumatic or hydraulic cylinders, magnetic relays or solenoids, or analog outputs. The input/output arrangements may be built into a simple PLC, or the PLC may have external I/O modules attached to a computer network that plugs into the PLC.

Static electricity generation may be a problem in these types of devices and is often dependent on the medium that is being carried. To circumvent such problems, atomized water can be introduced into the blowers' intake. Once the air is humidified, static discharge is prevented. Other methods, such as discharge rings or air ionizers, can also be used for the same purpose.

All components described above may be used with the system 10 of FIGS. 1 and 2, according to the features that are required for the application of viscous substances.

1. A method for applying a viscous substance at a given location comprising:
storing at least a first liquid at a position remote from the given location;
storing at least a first granular solid at a position remote from the given location;
conveying the first liquid and the first granular solid to the given location in separate pipes;
mixing at least the first liquid and the first granular solid under pressure to create the viscous substance; and
outletting the viscous substance under pressure to apply the viscous substance at the given location.

2. The method according to claim 1, further comprising storing a second liquid at a position remote from the given location, conveying the first liquid, the second liquid and the first granular solid to the given location in separate pipes, and mixing the first liquid, the second liquid and the first granular solid under pressure to create the viscous substance.

3. The method according to claim 2, wherein mixing the first liquid, the second liquid and the first granular solid comprises mixing the first liquid and the second liquid prior to mixing them with the first granular solid.

4. The method according to claim 1, further comprising storing at least a second granular solid at a position remote from the given location, conveying the second granular solid with the first granular solid to mix at least with the first liquid.

5. The method according to claim 1, wherein conveying the first granular solid comprises entraining the first granular solid in a pneumatic flow or transfer.

6. The method according to claim 1, further comprising creating a turbulent flow of the first granular solid prior to mixing the first granular solid with at least the first liquid.

7. The method according to claim 1, further comprising heating at least the first liquid during said storing.
